(19) United States
(12) Patent Application Publication
(10) Pub. No.: US 2024/0411519 A1
(43) Pub. Date: Dec. 12, 2024

(54) QUANTIZATION OF WEIGHTS IN A NEURAL NETWORK

(71) Applicant: STMicroelectronics International N.V., Geneva (CH)

(72) Inventors: Pascal URARD, Theys (FR); Nathan BAIN, Grenoble (FR)

(73) Assignee: STMicroelectronics International N.V., Geneva (CH)

(21) Appl. No.: 18/736,783

(22) Filed: Jun. 7, 2024

(30) Foreign Application Priority Data
Jun. 9, 2023 (EP) 23305924.5
Sep. 1, 2023 (FR) 2309178

(51) Int. Cl. G06F 7/544; G06F 5/01; G06F 7/50; G06F 7/523

(52) U.S. Cl. CPC G06F 7/5443; G06F 5/01; G06F 7/50; G06F 7/523

(57) ABSTRACT

The present description concerns a circuit configured to perform a multiply and accumulate operation in a layer of an artificial neural network, the operation taking, as an input, an input data value and a weight, and wherein the weight only has a value within a limited set only formed of value 0, of a plurality of values equal to 2ⁿ, where n is an integer, and of a plurality of values, each equal to the product of 2ⁿ by an odd number greater than or equal to 3.

### PRIORITY CLAIM

This application claims the priority benefit of European Application for Patent No. 23305924.5, filed on Jun. 9, 2023, and French Application for Patent No. 2309178, filed Sep. 1, 2023, the content of which is hereby incorporated by reference in its entirety to the maximum extent allowable by law.

### TECHNICAL FIELD

The present disclosure generally concerns the architecture of artificial neural networks and, in particular, a circuit or a method for performing multiply and accumulate operations in a neural network.

### BACKGROUND

The operations performed in each layer of artificial neural networks and, in particular, in the convolutional layers, imply the use of a hardware circuit configured to perform the multiply and accumulate operations (MAC). Such MAC circuits generally comprise a multiplier, implemented by combinational logic, followed by an adder.

However, MAC circuits have a high cost in terms of energy consumption and surface area. In particular, the multiplier has a significant role in the power and surface area consumption of the processor having the MAC circuit implemented thereon.

When the parameters, such as the weights of the neurons, are values quantized into fixed point values, there appear rounding errors. There exists a need for a representation of the parameters in quantized values enabling to limit rounding errors.

There also exists a need to decrease the power consumption, and the surface area, required for the hardware implementation of MAC circuits. In particular, there exists a need to provide a simplified implementation of a multiplier adapted to a quantized value representation.

### SUMMARY

An embodiment provides a circuit configured to perform a multiply and accumulate (MAC) operation in a layer of an artificial neural network, the MAC operation taking, as an input, an input data value and a weight, and wherein the weight only has a value within a limited set only formed of value 0, of a plurality of values equal to 2ⁿ, where n is an integer, and of a plurality of values, each equal to the product of 2ⁿ by an odd number greater than or equal to 3.

According to an embodiment, the circuit comprises: a first sub-circuit configured to perform a multiplication of an input data value by said odd number, the first sub-circuit comprising a first shift circuit configured to perform a multiplication by 2 and an adder; and a second sub-circuit configured to perform a multiplication by value 2ⁿ, the second sub-circuit comprising a second shift circuit configured to perform an n-bit shift.

According to an embodiment, the first sub-circuit further comprises a first multiplexer configured to supply the adder with a value selected from among: an output of the first shift circuit; and value 0, wherein the first multiplexer is configured to select the output of the first shift circuit if the weight is equal to one of said plurality of values equal to the multiplication of 2ⁿ by an odd number greater than or equal to 3.

According to an embodiment, the circuit further comprises a second multiplexer configured to supply the first sub-circuit with a value selected from among: the input data value; and value 0, wherein the second multiplexer is configured to select value 0 if the weight is equal to 0.

According to an embodiment, the circuit further comprises a third sub-circuit configured to apply, selectively, a negative sign to an output value of the first sub-circuit, the third sub-circuit comprising, for example, an inverter, an adder configured to add 1, and a third multiplexer configured to bypass, selectively, the inverter and the adder.

According to an embodiment, each weight is encoded over at least 4 bits, the at least 4 bits comprising: one bit encoding the sign of the weight; at least one bit indicating whether the value of the weight is a value from among the plurality of values equal to the product of 2ⁿ by an odd number greater than or equal to 3; and at least two bits encoding the value of n.

According to an embodiment, the second shift circuit is configured to perform a multiplication by a power of 2, based on the value of the at least two bits encoding an exponent of 2.

According to an embodiment, integer n is smaller than 3.

According to an embodiment, said plurality of values equal to product of the plurality of values 2ⁿ by an odd number greater than or equal to 3 comprises:
a first plurality of values equal to the product of the plurality of values 2ⁿ by a first odd number; and a second plurality of values equal to the product of the plurality of values 2ⁿ by a second odd number, different from the first odd number.

According to an embodiment, the odd number is number 3.

According to an embodiment, the odd number is number 3 and/or number 5 and/or number 7.

According to an embodiment, the weight value equal to 0 is encoded by a specific value, for example binary sequence X111, where X is equal to 0 or 1.

According to an embodiment, the layer is a convolutional layer.

Another embodiment provides a method of generation, by a circuit, of a weighted output value of a neuron of a layer of a neural network, the method comprising the multiplication of an input data value by a weight, wherein the weight only has a value within a limited set only formed of value 0, of a plurality of values equal to 2ⁿ, where n is an integer, and of a plurality of values, each equal to the product of 2ⁿ by an odd number greater than or equal to 3.

Another embodiment provides a method for training an artificial neural network, comprising the determination of weights of neurons, the determination being performed by selecting each weight only within a limited set only formed of value 0, of a plurality of values equal to 2ⁿ, where n is an integer, and of a plurality of values, each equal to the product of 2ⁿ by an odd number greater than or equal to 3.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 illustrates an example of a convolutional neural network;

FIG. 2 illustrates the hardware implementation of a multiply and accumulate operation;

FIG. 3 illustrates an operation of quantization over 8 bits;

FIG. 4A is a histogram of weight values;

FIG. 4B is a graph illustrating a Gaussian quantization;

FIG. 5 is a block diagram illustrating a multiplier;

FIG. 6 illustrates a test of validation of the quantization operation;

FIG. 7 is a table comprising the results of the validation tests; and

FIG. 8 is a graph showing a plurality of quantization modes for a VGG-type neural network model.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the operation and the implementation of artificial neural networks are known by those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

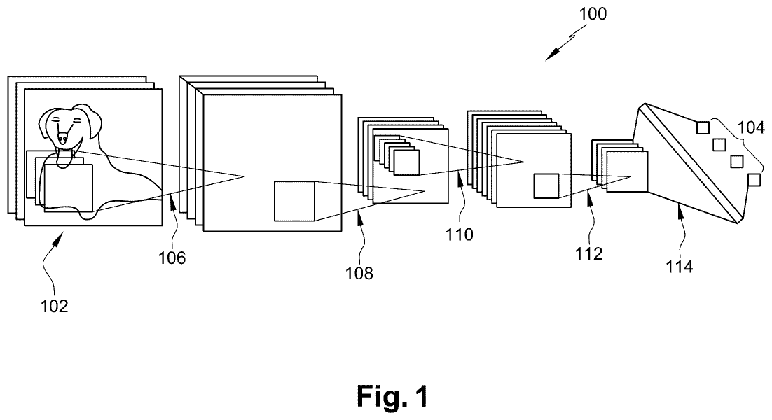

FIG. 1 illustrates an example of a convolutional neural network 100. As an example, the illustrated neural network 100 is configured to perform image recognition. More particularly, based on an input image 102, illustrating for example a dog, neural network 100 is configured to estimate probabilities of belonging to one or a plurality of classes of objects. Neural network 100 is thus configured to, for example, generate an output data element 104, for example a vector, indicating probabilities of membership, of input image 102, to classes, or categories, such as, for example, “dog”, “cat”, “lion”, and “bird”. Other examples of image processing and other categories are of course possible. Similarly, in other examples, neural network 100 is configured to generate an output vector 104 comprising the membership probabilities of input image 102 to more than some ten, or some hundred, classes. The example of a network configured to perform image processing is of course not limiting. Generally, neural network 100 comprises at least one convolutional layer.

As an example, input image 102 is successively processed by a series of layers of neural network 100. As an example, the first layer of network 100 is a convolutional layer 106 configured to detect features in input image 102, such as for example, contours, shapes, colors, and/or textures. Layer 106 is for example followed by a pooling layer 108 configured to decrease the dimensions of the image and thus enable to decrease the number of parameters and of calculations performed in network 100. Layer 108 is for example followed by a new convolutional layer 110. Layer 110 is for example configured to detect features in input image 102, such as for example, contours, shapes, colors, and/or textures. As an example, the features detected by layer 110 are finer features than those detected by layer 106. For example, layer 106 will be configured to detect colors and/or contours and layer 110 will be configured to detect patterns and/or textures in the image. As an example, layer 110 is followed by a new pooling layer 112, itself coupled to a fully connected layer 114 configured to combine the features extracted from the previous layers to generate output vector 104.

Each of layers 106, 108, 110, 112, and 114 is associated with one or a plurality of parameters, such as for example, weights associated with each neuron of a layer. The value of each parameter, and in particular of each weight, is a value learnt during the training, or learning, of network 100. Once the values of the parameters have been set, that is, when the training of network 100 is considered as ended, network 100 is used to perform, via the series of layers 106 to 114, inference operations. In particular, during the execution of network 100, operations of multiply and accumulate (MAC) type are performed. MAC operations correspond, for example, to the summing, over a plurality of neurons of a layer, of the products between a value supplied to a neuron and for example, the weight associated with this neuron. In other words, a MAC operation, over a number N of neurons, N being an integer greater than or equal to 1, corresponds to performing the following operation: Σᵢ₌₁^{N}wᵢxᵢ, where wᵢ is the weight associated with the neuron of rank i and where xᵢ is the input value supplied to the neuron of rank i.

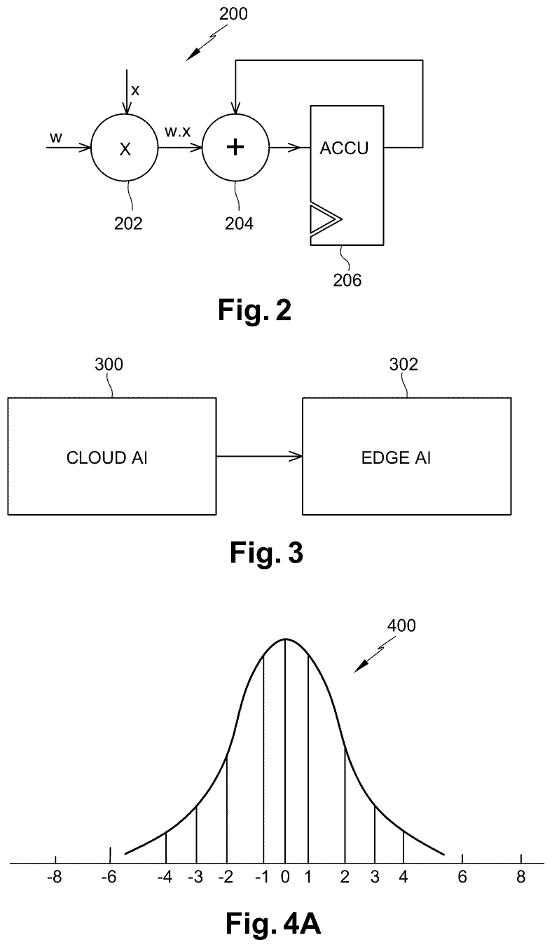

FIG. 2 illustrates an example of hardware implementation 200 of a multiply and accumulate operation.

As an example, implementation, or circuit, 200 comprises a multiplier 202 (×) configured to receive two input values and to generate an output value w. x corresponding to the product of the two input values. As an example, the two input values supplied to the multiplier respectively correspond to an input value x towards a neuron and the weight w associated with this neuron. Circuit 200 further comprises an adder 204 (+). Adder 204 is for example coupled to multiplier 202, and multiplier 202 is configured to deliver the generated output value to adder 204. Adder 204 is, for example, further coupled to a memory 206 (ACCU). As an example, memory 206 is a register. As an example, adder 204 is further configured to read the value stored in memory 206 and to generate an output value by adding it to the value supplied by multiplier 202. Adder 204 then is, for example, configured to store the value generated in memory 206. As an example, the storage of the generated value is performed as a result of the suppression of the value which has been previously read by adder 204.

The values manipulated by MAC circuits such as circuits 200 are values quantized into sets of values. The quantized values are, for example, fixed point values.

FIG. 3 illustrates an operation of quantization of the weights of network 100 over 8 bits.

As an example, the training of network 100 is performed by a device external to the circuit on which it will be implemented. As an example, the external device is a device having a high computing capacity. After the training, the weights are, for example, stored in a memory 300 (CLOUD AI), external to the circuit on which network 100 will be implemented. As an example, memory 300 is a server. As an example, the weights stored in memory 300 are floating point numbers and are for example coded over 16 or 32 bits.

As an example, before being stored in a memory of a device in which network 100 will be implemented, the learnt weight values are quantized, or transformed, into quantized values being integer values or into fixed point values. As an example, the quantization is performed by a compiler for the porting to a peripheral circuit 302 (EDGE AI). As an example, peripheral circuit 302 is configured to perform operations according to network edge computing methods.

As an example, circuit 302 is configured to transform the weight values transmitted by memory 300 into integer values, and for example over a number smaller than 16 bits, for example over 8 or 4 bits.

As an example, circuit 302 is configured to quantize the weight values over 8 bits by performing a linear operation. As an example, for a floating point value r, for example coded over 32 or over 16 bits, an integer value q, for example coded over 8 bits, is such that r=S. (q−Z), where value S is a real and positive constant representing a scaling factor, value Z is a zero offset corresponding to the value quantizing value 0. The linear operation thus described is known by those skilled in the art and is for example described in part 2 of publication “Quantization and Training of Neural Networks for Efficient Integer-Arithmetic-Only Inference” by B. Jacob, et al. (incorporated herein by reference). In this example, and in relation with FIG. 2, the input data supplied to multiplier 202 are, for example, data coded over 8 bits. Multiplier 202 is for example then configured to generate, based on the two input values coded over 8 bits, a value coded over 16 bits.

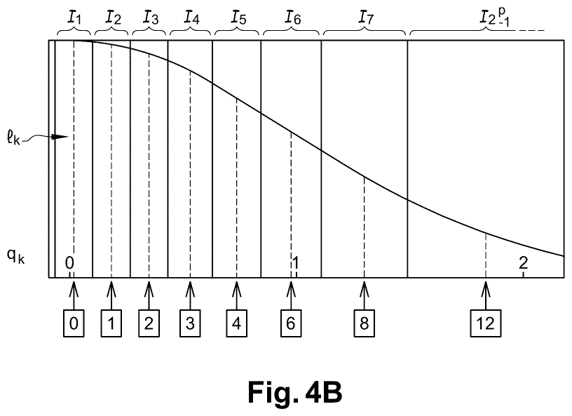

FIG. 4A is a histogram 400 of weight values. In particular, histogram 400 illustrates a Gaussian distribution of values belonging to a set of integer values Q₃ where Q₃=={0} ∪_{n∈ N}{±2ⁿ} ∪_{n∈ N}{±3. 2ⁿ}. In other words, set Q₃ only comprises, for example, value 0, integers equal to powers of 2, such as for example values −4, −2, −1, 1, 2, 4, etc., and integers equal to powers of 2, multiplied by 3, such as for example, −6, −3, 3, 6, etc. In another example, value 0 does not belong to set Q₃.

According to an embodiment, circuit 302 is for example configured to quantize the value of the weights stored in memory 300 into values belonging to set Q₃. According to an embodiment, for a floating point value r, a so-called simple quantization into a value q belonging to set Q₃ is performed by applying an operation such as q=sign(r)└S·r┘^{Q}^{₃}, where sign(r)=1 if r is positive and sign(r)=−1 if r is negative and where, for any floating point value x └x┘^{Q}^{₃} is the value belonging to Q₃ closest to the absolute value of value x. As an example, for r=−5.3, └S·r┘^{Q}^{₃}=6 and q=−6.

According to an embodiment, each circuit having network 100 implemented thereon is configured to manipulate and store the quantized values, belonging to set Q₃.

According to other embodiments, set Q₃ is replaced, or completed, by one or a plurality of other sets only comprising values equal to the product of powers of 2 by an odd number different from 3, for example by 5 and/or 7, etc. As an example, set Q₃ is replaced with set Q₃ ∪ Q₅, or Q₅:={0} ∪_{n∈ N}{±2ⁿ} ∪_{n∈ N}{±5. 2ⁿ} and the quantization is performed in set Q₃ ∪ Q₅. In another example, the quantization is only performed in set Q₅. Generally, the quantization is only performed in a set, or in an assembly of sets, of form Q₂ₚ₊₁, where Q₂ₚ₊₁:={0} ∪_{n∈ N}{±2ⁿ} ∪_{n∈ N} {±(2p+1)·2ⁿ}, p being a positive integer number. However, the most advantageous hardware combinations of the implementation of the MAC circuit are values which are the sum of two powers of two.

FIG. 4B is a graph illustrating a Gaussian quantization as an alternative to the quantization described in relation with FIG. 4A.

As an example, the quantization to values in Q₃ is performed by so-called Gaussian quantization operations. As an example, the quantization in Q₃ is performed over a number p of bits, for example 4 bits. In other words, the quantized values are encoded over a number p of bits. To discretize the weight values over p bits, it is assumed that they follow a standard normal distribution of variance σ². As an example, the value of variance σ² is statistically obtained from samples of weight values. A number 2^{p}−1 of intervals Iₖ, k ∈{1, . . . , 2^{p}−1} is defined so that a probability of membership of a random variable of distribution N(0, σ²) to an interval is uniform, that is, equal to 1/(2^{p}−1), whatever the interval. Interval I₁ then has form I₁=]−∞, b₁], interval I₂_{^{p}}₋₁ has form I₂_{^{p}}₋₁=[b₂_{^{p}}₋₂, +∞[. Intervals Iₖ, k ∈ {2, . . . , 2^{p}−2} have form [bₖ₋₁, bₖ[. Terminals bₖ then are values depending on p and on σ₂. The density of a standard normal distribution being symmetrical and 2^{p}−1 being an odd number, for any k ∈{1, . . . , 2P −1}, bₖ=−b₂_{^{p}}₋₁₋ₖ, value 0 is a quantized value. For each interval Iₖ, k ∈ {2, . . . , 2^{p}−2}, a value lₖ is defined such that:

$${l}_{k} = σ \sqrt{2} \cdot {erf}^{- 1} ( \frac{erf ( {b}_{k} / σ \sqrt{2} ) + erf ( {b}_{k - 1} / σ \sqrt{2} )}{2} ) ,$$

where erf is the error function. As an example, for p=4 and σ²=1, the values lₖ rounded to within one hundredth are equal to {−1.83, −1.28, −0.97, −0.73, −0.53, −0.34, −0.17,0,0.17,0.34, 0.53,0.73,0.97,1.28,1.83}. To avoid manipulating floating point values, values lₖ, k ∈ {1, 2^{p}−1} are linearly transformed into values qₖ=└lₖ·A_{G}┘^{Q} where A_{G} ∈ R is an approximation factor and where Q⊂Z is a set of quantized values, for example Q=Q₃. As an example, value A_{G} may be obtained by linear regression,

$${A}_{g} = \frac{{Σ}_{i} {l}_{i} \cdot {q}_{i}}{{Σ}_{i} {l}_{i}^{2}} .$$

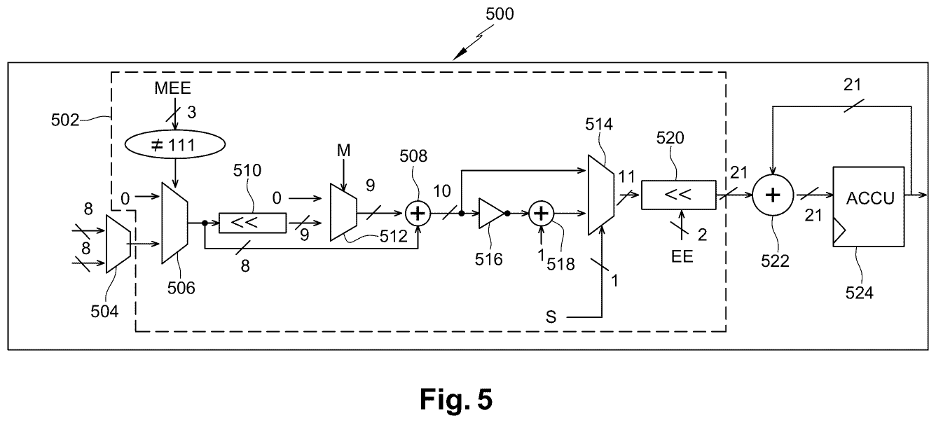

FIG. 5 is a block diagram illustrating a multiply and accumulate circuit 500, according to an embodiment of the present disclosure.

According to an embodiment, the values belonging to Q₃ are coded over at most 4 bits. A bit, for example the most significant bit, is a sign bit, another bit, for example the second most significant bit, indicates whether the value is, for example, a multiple of 3. Eventually, the two remaining bits, for example the two least significant bit, encode the value of exponent n. As an example, n=0 if the value is odd, n=1 if the value is equal to ±2 or ±6, etc. Exponent n being limited over 2 bits, set Q₃ is then limited to values {−12, −8, −6, −4, −3, −2, −1, 0, 1, 2, 3, 4, 6,8, 12}. Thus, for example, the value over 4 bits 0000 encodes, for example, value 1, the value over 4 bits 1101 encodes, for example, −6, etc. This example of coding over 4 bits is of course disclosed as an example and other forms of codings may of course be envisaged. In another example, the least significant bit is the sign bit and the two most significant bits encode the value of exponent n. As an example, the value over 4 bits X111 encodes value 0, where X is a bit of value 0 or 1.

Generally, in the case where the quantization is only performed in a set of form Q₂ₚ₊₁, the second most significant bit for example indicates whether the value is a multiple of 2p+1 or not.

Value 0000 then coding a value different from 0, in the case where those skilled in the art desire for weights of network 100 to have the possibility of being zero, they will be capable of encoding, specifically, weight value 0.

According to an embodiment shown in FIG. 5, a MAC circuit 500 comprises a multiplier circuit 502. Multiplier circuit 502 is configured to receive an activation value, corresponding to an input value for example transmitted to a neuron of network 100. As an example, the input value is supplied to multiplier circuit 502 via a multiplexer 504. As an example, the activation value supplied to multiplexer 504 is a value over 8 bits. As an example, multiplexer 504 is configured to supply circuit 502 with an activation value, being equal either to value 0, or to a non-zero value. As an example, multiplexer 504 is present when the activations are encoded with a shift by value zero. As an example, multiplexer 504 is omitted when the activations are not encoded with a shift by value 0. In this case, the activations are supplied as inputs of multiplexer 502.

In particular, multiplexer 504 is coupled to a multiplexer 506 of circuit 502. Multiplexer 506 is configured to select value 0, or the activation value supplied by multiplexer 504, based on the values of the three bits indicating whether the weight value is a multiple of 3 (M) and indicating the value of exponent n (EE). As an example, if at least one of the three bits is different from 1 (≠111), multiplexer 506 is configured: to select the activation value, corresponding to the case where the weight value is different from value 0; and to select value 0 in the case where the three bits are encoded at value 1. The value selected by multiplexer 506 then is, for example, a value over 8 bits and is transmitted to an adder 508. The value selected by multiplexer 506 is concurrently supplied to a shift circuit 510 (<<1). Shift circuit 510 then generates a value encoded over, for example, 9 bits, which is the value supplied by multiplexer 506 shifted leftwards by one bit, thus corresponding to its multiplication by 2. Circuit 510 is further coupled to a multiplexer 512 configured to select, based on the value of the bit (M) indicating whether the value of the weight is a multiple of 3, the output of circuit 510, or value 0. As an example, if the value of the weight is not a multiple of 3, multiplexer 512 is configured to select value 0 and, if the weight value is a multiple of 3, multiplexer 512 is configured to select the output value of circuit 510. The selected value is then transmitted to adder 508. Adder 508 is then configured to add the output values of multiplexers 506 and 512. As an example, circuit 510 comprises a grounded wire configured to add bit “0” as a least significant bit to the input value. Shift circuit 510 is, for example, a symbolic component.

Thus, in the case where the weight value is a multiple of 3, the output value of adder 508 corresponds to three times the input value. In the case where the weight value is not a multiple of 3, without being value 0, the output value of the adder 508 corresponds to the activation value. As an example, the value generated by adder 508 is a value over 10 bits.

The value generated by adder 508 is then supplied to a multiplexer 514 and, in parallel, to an inverter 516. Inverter 516 is thus configured to switch the bits having value 1 to value 0, and conversely, from the value supplied by adder 508. The inverted value is then supplied to an adder 518. Adder 518 is an adder by 1, configured to add 1 to the output value of inverter 516. Inverter 516 and adder 518 are thus configured to generate, according to the 2's complement method, the value opposite to the output value of adder 508. The output value of adder 518 thus corresponds to the value which, when it is added to the output value of adder 508, results in a series of 0s. In other words, the output value of adder 518 corresponds to the multiplication of the output value of adder 508 by −1.

Multiplexer 514 is then configured to select, based on the value of the bit (S) indicating whether the weight value is positive or negative, the output value of adder 508 or of adder 518. For example, if the weight value is positive, multiplexer 514 selects the output value of adder 508, and if the weight value is negative, multiplexer 514 selects the output value of adder 518.

Multiplexer 514 is then configured to supply the selected value, for example over 11 bits, to a shift circuit, or shifter 520. Shift circuit 520 is then configured to shift leftwards the received value based on the value of the two bits (EE) indicating the exponent. As an example, if the two bits are equal to 0, circuit 520 simply restores the output value of multiplexer 514, without shifting it. Generally, circuit 520 is configured to shift the supplied value by a number of bits equal to the value of n. The value restored by circuit 520 then corresponds to the product of the output value of multiplexer 514 by 2ⁿ. As an example, the output value of circuit 520 is a value over 21 bits.

Multiplier 502 is further coupled to an adder 522 configured to read the output value of circuit 520. Adder 522 is further configured to add the output value of circuit 520 to a value stored in a memory 524 (ACCU). Adder 522 is further configured to transmit the generated value to memory 524. As an example, memory 524 is similar to memory 206. As an example, the values manipulated by adder 522 are coded over 21 bits.

The numbers of bits manipulated by the elements of multiplier 502 and by adder 522 are given as an example. As an example, in the case where exponent n is coded over a number of bits greater than 2, those skilled in the art will be capable of adapting the number of bits manipulated by different elements of circuit 500 to the number of bits encoding the weight value as well as the shift carried out by circuit 520.

In the case where the weight value belongs to a set of type Q₂ₚ₊₁, p≥2 or to the assembly of a plurality of sets of type Q₂ₚ₊₁, p≥1, those skilled in the art will be capable of adjusting the portion of circuit 502 comprising elements 506, 510, 512, and 508 in order to replace them, or of adding other elements to perform a multiplication by the desired odd numbers. As an example, if the considered set has form Q₃ ∪ Q₅, another multiplexer may be added to select whether the weight value is a multiple of 5 or not, and this other multiplexer may be coupled to an adder and to a shift circuit configured to shift, leftwards by at least one bit, the received value. The number of bits implied in the shift depends on the number of bits used to encode the value of the exponent of 2. According to the position of this other multiplexer, the circuit may be adjusted to set Q₇ without having to add another additional hardware component. In this case, set Q₇ will correspond to (1×A+2×A)+4×A, where a first multiplexer will choose to add value 2×A or not, in the same way as multiplexer 512, and a second multiplexer will choose to add value 4×A or not. Generally, the more assemblies of sets of type Q₂ₚ₊₁ are comprised in the considered set, the more the representation will be close to a floating point description. Generally, circuit portion 502 comprises a number of adders equal to the number of “Is” in the binary representation of the odd number, minus one. For example, the binary representations of odd numbers 3 and 5 are “011” and “101”, comprising two values “1”, whereby the portion 502 adjusted to Q₃ or to Q₅ comprises an adder. For example, the binary representation of the odd number is “111” comprising three values “1”, whereby the portion 502 adapted to Q₇ comprises two adders.

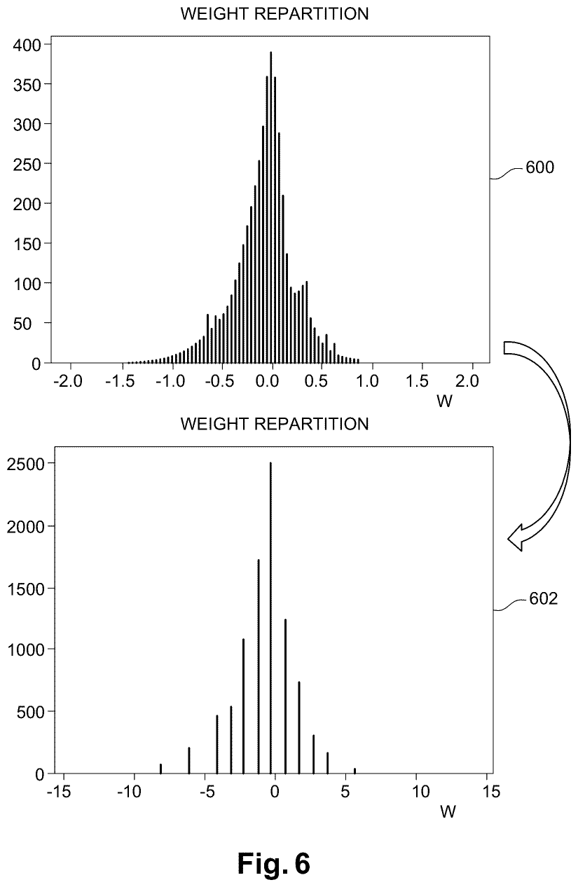

FIG. 6 illustrates a test of validation of the quantization in set Q₃.

As an example, the illustrated validation test is performed as a result of the learning of the weights of a convolutional layer of a network for example similar to the neural network 100 described in relation with FIG. 1. As an example, the network is a network of Convolutional Neural Network (CNN) type.

A histogram 600 illustrates the distribution of the weights (WEIGHT REPARTITION) obtained, during the training, for the second layer of the network. More particularly, the weights illustrated in histogram 600 are floating point values. The weight distribution then forms a Gaussian curve.

A histogram 602 illustrates the distribution of the quantized weights. As an example the quantized weights are the weights obtained, during the training, for the second layer of the network, and then quantized into set Q₃. As an example, based on a floating point weight r, a quantized weight q is such that q=sign(r)[S·r]^{Q}^{₃}. The distribution of the quantized weights in Q₃ thus forms a Gaussian curve. Further, it can be observed that all the quantized weights belong to interval [−12,12] and may accordingly be coded over 4 bits as described in relation with FIG. 5.

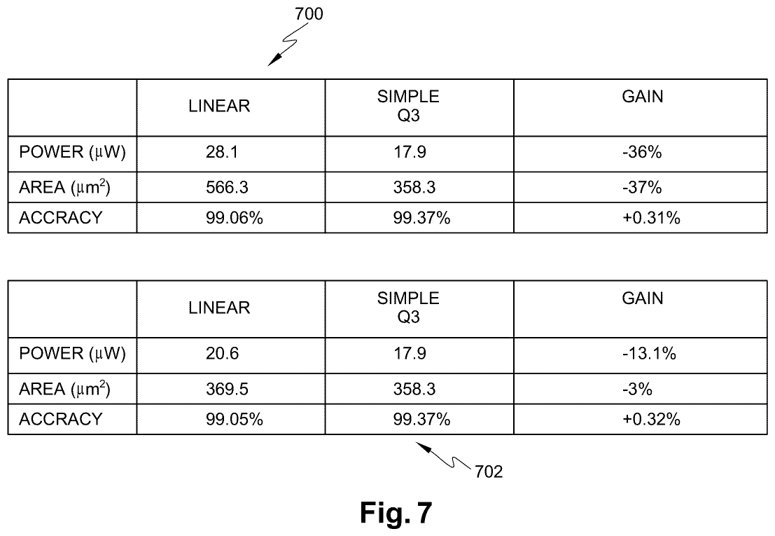

FIG. 7 illustrates a table 700 and a table 702, each comprising the results of validation tests. In particular, tables 700 and 702 comprise comparisons of the costs in terms of power consumption (POWER (μW)), of surface area (AREA (μm²)), as well as the accuracy of the network (ACCURACY) for a linear quantization (LINEAR) and a quantization into Q₃, over 4 bits (SIMPLE Q₃). In particular, table 700 illustrates a comparison between a linear quantization (LINEAR), for example described in relation with FIG. 3, over 8 bits and the quantization into Q₃ over 4 bits. Table 702 illustrates a linear quantization over 4 bits and the quantization into Q₃ over 4 bits. The comparison is for example performed for a convolutional layer of a neural network similar to network 100 and having data for activating the layer coded therein, by a linear quantization, over 8 bits. The quantizations are then performed for the weights of neurons of said layer, and based on floating point values, obtained for example during the training of the network.

As an example, the linear quantization over 8 bits enables to quantize floating point values into integers for example belonging to interval [symbol] 0, 255 [symbol] . The linear quantization over 4 bits enables to quantize floating point values into integers for example belonging to interval [symbol] 0, 15 [symbol] . More particularly, the linear quantization over 8 bits comprises 256 representations of values for the weights and the linear quantization over 4 bits comprises 16 representations. The quantization into Q₃ over 4 bits comprises, as described in relation with FIG. 5, 15 representations, including value 0. A gain column (GAIN) in each table 700 and 702 comprises the gains in terms of power consumption, surface area, and accuracy provided by the quantization into Q₃ over the linear quantization. As an example, the surface area used by the quantization into Q₃ over 4 bits is calculated based on the implementation of the MAC circuit 500 described in relation with FIG. 5.

As an example, for a tested 40-nm technology, a linear quantization over 8 bits, respectively over 4 bits, requires for example a 28.1-μW, respectively 20.6-μW, power consumption while the quantization into Q₃ for example requires 17.9 ρW, which amounts to a gain of 36% in the first case and of 13.1% in the second case. Similarly, the linear quantization over 8 bits, respectively over 4 bits, for example requires a 566.3-μm², respectively 369-μm², surface area, while the quantization into Q₃ for example requires 358 μm², which amounts to a gain of 37% in the first case and of 3% in the second case.

The accuracy in the case of the linear quantization over 8 bits is for example of 99.06% and of 99.05% in the case of the linear quantization over 4 bits. The accuracy for the quantization into Q₃ is for example of 99.37%, that is, a gain of 0.31% over the linear quantization over 8 bits and of 0.32% over the linear quantization over 4 bits.

Although the quantization into Q₃ and over 4 bits allows the coding of the weight values only in a set of 14 values, or 16 if values −24 and 24 are included, or 15 including value 0, the latter are more spread out to more judiciously and cleverly cover the Gaussian distribution, which results in a higher accuracy. Indeed, the 16 values described by the linear representation over 4 bits are much too few and all at an equal distance from one another, which is not ideally adapted to describing values distributed according to a normal distribution. Further, the 256 values described by the linear representation over 8 bits, although enabling to faithfully describe the Gaussian distribution, are too many. Indeed, the tail values, that is, the high and low values, are very seldom used and the fact of considering them increases the surface area and the power consumption without for all this to provide a significant accuracy gain.

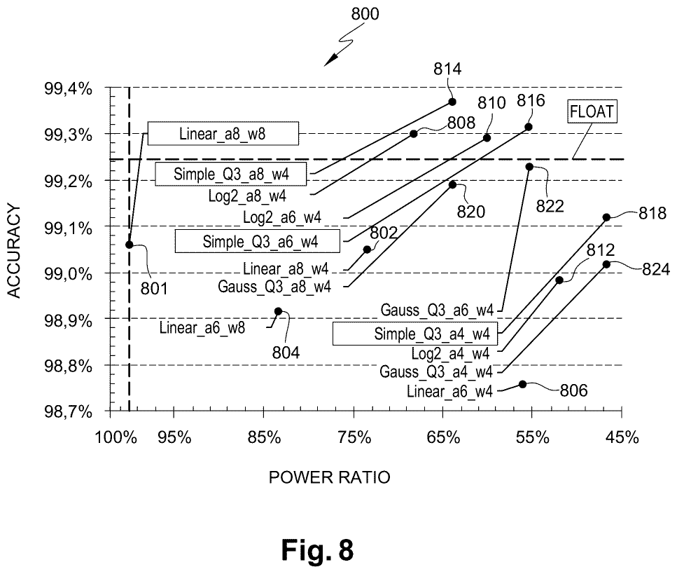

FIG. 8 is a graph 800 showing a plurality of quantization modes for a neural network model of Visual Geometry Group (VGG) type. This model is characterized by the succession of blocks formed of from two to three convolutional layers followed by a layer called maxpooling layer. Each convolutional layer comprises a 3-by-3 filter and the maxpooling layers have a 2-by-2 size. As an example, a VGG16 model has a depth of 16 layers and a VGG19 model has a depth of 19 layers. In particular, graph 800 comprises a plurality of points, each associated with a quantization model. The abscissa of each point represents the power ratio and the ordinate of each point represents the accuracy obtained by the VGG network. The power ratio is defined with respect to a power consumption of the linear quantization with 8 weight bits and 8 activation bits. As an example, a 65% ratio signifies that the tested quantization consumes 35% less energy than the linear quantization over 8 bits. As an example, the parameters of the VGG network have been obtained by training and are, basically, floating point values (FLOAT). The different illustrated quantizations are for example performed over the weights of the convolutional layers of the network. As an example, a first training of the network is performed with floating point values, after which a second training is performed, based on the weight obtained during the first training, to simulate a quantization. This technique is known by those skilled in the art as Quantization Aware Training (QAT). As an example, for each point, between 10 and 20, for example 15, trainings of the network are performed and the maximum accuracy is restored.

As an example, points 801 (Linear_a8_w8), 802 (Linear_a8_w4), 804 (Linear_a6_w8), and 806 (Linear_a6_w4) represent the power ratio and the accuracy of the VGG network for linear quantizations. In particular, point 801 is associated with a linear quantization over 8 bits, and for which the activation points are also over 8 bits. Point 802 is associated with a linear quantization over 4 bits, and for which the activation points are also over 8 bits. The accuracy provided by these two quantizations is similar, that is, of approximately 99.05%, but the quantization over 4 bits is less costly in terms of power consumption. Point 804 and 806 are associated with a linear quantization respectively over 8 and 4 bits, and for which the activation points are also over 6 bits.

Points 808 (Log 2_a8_w4), 810 (Log 2_a6_w4), and 812 (Log 2_a4_w4) are associated with logarithmic quantizations over 4 bits, and for which the activation points are, respectively, over 8, 6, and 4 bits.

Points 814 (Simple_Q₃_a8_w4), 816 (Simple_Q₃_a6_w4), and 818 (Simple_Q₃_a4_w4) are associated with simple quantizations in Q₃ over 4 bits, such as described in relation with FIG. 4A, and for which the activation points are, respectively, over 8, 6, and 4 bits.

Points 820 (Gauss_Q₃_a8_w4), 822 (Gauss_Q₃_a6_w4), and 824 (Gauss_Q₃_a4_w4) are associated with Gaussian quantizations, such as described in relation with FIG. 4B, in Q₃ over 4 bits, and for which the activation points are, respectively, over 8, 6, and 4 bits.

Graph 800 show that for the tests performed, the linear quantizations result in a poorer accuracy than by keeping floating point values. However, quantizations into Q₃, in particular having activation points over 8 and/or 6 bits, have a better accuracy than when keeping floating point values.

An advantage of the embodiments is that they enable to implement a MAC circuit adapted to the operations executed by one or a plurality of layers of a neural network and having a decreased surface area.

Various embodiments and variants have been described. Those skilled in the art will understand that certain features of these various embodiments and variants may be combined, and other variants will occur to those skilled in the art. In particular, the set having the quantization performed thereon may vary. Indeed, although the set Q₃ over 4 bits is mainly described, those skilled in the art will be capable of adapting the implementation of the MAC circuit to a Q₂p+₁-type set, or to the assembly of a plurality of Q₂p+₁-type sets. Similarly, those skilled in the art will be capable of adapting the encoding of the values of Q₃ and their processing by the MAC circuit, when they are coded over a number greater than 4 bits.

Finally, the practical implementation of the described embodiments and variants is within the abilities of those skilled in the art based on the functional indications given hereabove. In particular, those skilled in the art will be capable of adapting the implementation of circuit 502 to perform multiplications by one, or a plurality of, odd numbers different from 3.

1. A circuit, comprising:
a layer of an artificial neural network configured to perform a multiply and accumulate (MAC) operation;
wherein the MAC operation receives, as an input, an input data value and a weight; and
wherein the weight has a value within a limited set formed only of: value 0; a plurality of values equal to 2ⁿ, where n is an integer; and a plurality of values that are each equal to a product of 2ⁿ by an odd number greater than or equal to 3.

2. The circuit according to claim 1, comprising:
a first sub-circuit configured to perform a multiplication of the input data value by said odd number, the first sub-circuit comprising a first shift circuit configured to perform a multiplication by 2 and an adder; and
a second sub-circuit configured to perform a multiplication by value 2ⁿ, the second sub-circuit comprising a second shift circuit configured to perform a shift by n bits.

3. The circuit according to claim 2, wherein the first sub-circuit further comprises a first multiplexer configured to supply the adder with a value selected from among: an output of the first shift circuit; and value 0; and
wherein the first multiplexer is configured to select the output of the first shift circuit if the weight is equal to one of said plurality of values equal to the multiplication of 2ⁿ by an odd number greater than or equal to 3.

4. The circuit according to claim 2, further comprising a second multiplexer configured to supply the first sub-circuit with a value selected from among: the input data value; and value 0; and
wherein the second multiplexer is configured to select value 0 when the weight is equal to 0.

5. The circuit according to claim 2, further comprising a third sub-circuit configured to apply, selectively, a negative sign to an output value of the first sub-circuit, the third sub-circuit comprising, for example, an inverter, an adder configured to add 1, and a third multiplexer configured to bypass, selectively, the inverter and the adder.

6. The circuit according to claim 2, wherein each weight is encoded over at least 4 bits, the at least 4 bits comprising:
one bit encoding the sign of the weight;
at least one bit indicating whether the value of the weight is a value from among the plurality of values equal to the product of 2ⁿ by an odd number greater than or equal to 3; and
at least two bits encoding the value of n.

7. The circuit according to claim 6, wherein the second shift circuit is configured to perform a multiplication by a power of 2, based on the value of the at least two bits encoding an exponent of 2.

8. The circuit according to claim 1, wherein integer n is smaller than 3.

9. The circuit according to claim 1, wherein said plurality of values equal to the product of the plurality of values 2ⁿ by an odd number greater than or equal to 3 comprises:
a first plurality of values equal to the product of the plurality of values 2ⁿ by a first odd number; and
a second plurality of values equal to product of the plurality of values 2ⁿ by a second odd number that is different from the first odd number.

10. The circuit according to claim 1, wherein the odd number is number 3.

11. The circuit according to claim 1, wherein the odd number is selected from the group consisting of: 3, 5 and 7.

12. The circuit according to claim 1, wherein the weight value equal to 0 is encoded by a specific value comprising a binary sequence X111, where X is equal to 0 or 1.

13. The circuit according to claim 1, wherein the layer is a convolutional layer.

14. A method of generating, by a circuit, a weighted output value of a neuron of a layer of a neural network, the method comprising:
multiplying an input data value by a weight, wherein the weight has a value within a limited set formed only of: value 0; a plurality of values equal to 2ⁿ, where n is an integer; and a plurality of values that are each equal to the product of 2ⁿ by an odd number greater than or equal to 3.

15. The method according to claim 14, wherein multiplying comprises:
first multiplying the input data value by said odd number, the first multiplying comprising a first shifting configured to perform a multiplication by 2 and an addition; and
second multiplying by value 2ⁿ, the second multiplying comprising a second shifting by n bits.

16. The circuit according to claim 15, wherein the first multiplying supplies the addition with a value selected from among: an output of the first shifting; and value 0; and
further comprising selecting the output of the first shifting when the weight is equal to one of said plurality of values equal to the multiplication of 2ⁿ by an odd number greater than or equal to 3.

17. The circuit according to claim 15, further comprising selecting for the first multiplying a value selected from among: the input data value; and value 0; and
further comprising selecting value 0 when the weight is equal to 0.

18. The circuit according to claim 15, further comprising selectively applying a negative sign to an output value of the first multiplying by performing a 2's complement operation.

19. A method for training an artificial neural network, comprising:
determining weights of neurons;
wherein determining is performed by: selecting each weight within a limited set formed only of: value 0; a plurality of values equal to 2ⁿ, where n is an integer; and a plurality of values that are each equal to the product of 2ⁿ by an odd number greater than or equal to 3.

20. The method according to claim 19, wherein each weight is encoded over at least 4 bits, the at least 4 bits comprising:
one bit encoding the sign of the weight;
at least one bit indicating whether the value of the weight is a value from among the plurality of values equal to the product of 2ⁿ by an odd number greater than or equal to 3; and
at least two bits encoding the value of n.

21. The method according to claim 20,
wherein said plurality of values equal to the product of the plurality of values 2ⁿ by an odd number greater than or equal to 3 comprises:
a first plurality of values equal to the product of the plurality of values 2ⁿ by a first odd number; and
a second plurality of values equal to product of the plurality of values 2ⁿ by a second odd number that is different from the first odd number.

22. The method according to claim 20, wherein the odd number is number 3.

23. The method according to claim 20, wherein the odd number is selected from the group consisting of: 3, 5 and 7.

24. The method according to claim 20, wherein the weight value equal to 0 is encoded by a specific value comprising a binary sequence X111, where X is equal to 0 or 1.
